(19) United States
(12) Patent Application Publication
(10) Pub. No.: US 2017/0225426 A1
(43) Pub. Date: Aug. 10, 2017

(54) SYSTEM, METHOD AND APPARATUS FOR GYPSUM BOARD WITH EMBEDDED STRUCTURE HAVING OPEN CELLS THAT ARE SUBSTANTIALLY FILLED

(71) Applicant: CERTAINTEED GYPSUM, INC., Cody, WY (US)

(72) Inventors: Aldo GLEAN, Framingham, MA (US); Zhiqiang SHI, Shrewsbury, MA (US)

(21) Appl. No.: 15/426,750

(22) Filed: Feb. 7, 2017

Related U.S. Application Data
(60) Provisional application No. 62/292,794, filed on Feb. 8, 2016.

(51) Int. Cl. B32B 3/12; B32B 13/08; E04C 2/04; E04B 2/56; E04B 1/86

(52) U.S. Cl. CPC B32B 3/12; E04B 2/56; E04B 1/86; E04C 2/04; B32B 13/08; B32B 2307/102

(57) ABSTRACT

A gypsum panel has a gypsum body with a length L along an x-axis, a width W along a y-axis, and a thickness T along a z-axis. The gypsum body includes at least one core embedded at least partially within the gypsum body. Examples of the core include a hollow, open cell structure having walled elements. The walled elements have axes that can be substantially parallel to each other and the z-axis. The walled elements may be substantially filled with a same material as the gypsum body.

### CROSS-REFERENCE TO RELATED APPLICATION(S)

This application claims priority under 35 U.S.C. §119(e) to U.S. Patent Application No. 62/292,794 entitled “SYSTEM, METHOD AND APPARATUS FOR GYPSUM BOARD WITH EMBEDDED STRUCTURE HAVING OPEN CELLS THAT ARE SUBSTANTIALLY FILLED,” by Aldo Glean and Zhiqiang Shi, filed Feb. 8, 2016, which is assigned to the current assignee hereof and incorporated herein by reference in its entirety.

### BACKGROUND OF THE INVENTION

Field of the Disclosure

The present invention relates in general to gypsum panels and, in particular, to a system, method and apparatus for a gypsum board with an embedded structure having substantially filled open cells.

Description of the Related Art

Acoustic gypsum boards with improved acoustic performance compared to conventional gypsum products is desired for higher customer value. Existing approaches to improving the performance of single layer acoustic boards have been based on material formulation, such as a product known as PlacoPhonique. http://www.placo.fr/Solutions/Innovations-et-produits-phares/Produits-phares/Solutions-Placo-R-Phonique. Another solution introduces controlled micro-cracking into gypsum boards to improve acoustic performance. One example of such as a product is known as SoundBloc. http://www.british-gypsum.com/products/gyproc-soundbloc. Still other solutions have utilize laminated boards, such as SilentFX (http://www.certainteed.com/Products/340906) and QuietRock (www.quietrock.com), which use a viscoelastic glue layer between two boards. See, e.g., U.S. Pat. No. 7,745,005. Although each of these solutions is workable, improvements in gypsum panels continue to be of interest.

### SUMMARY

Embodiments of a system, method and apparatus for a gypsum panel are disclosed. For example, the gypsum panel may include a gypsum body with a length L along an x-axis, a width W along a y-axis, and a thickness T along a z-axis. The gypsum body may have at least one core embedded at least partially within the gypsum body. Examples of the core may include a hollow, open cell structure having walled elements. The walled elements have axes that may be substantially parallel to each other and the z-axis. In some embodiments, the walled elements may be substantially filled with a same material as the gypsum body.

The foregoing and other objects and advantages of these embodiments will be apparent to those of ordinary skill in the art in view of the following detailed description, taken in conjunction with the appended claims and the accompanying drawings.

### BRIEF DESCRIPTION OF THE DRAWINGS

So that the manner in which the features and advantages of the embodiments are attained and can be understood in more detail, a more particular description may be had by reference to the embodiments thereof that are illustrated in the appended drawings. However, the drawings illustrate only some embodiments and therefore are not to be considered limiting in scope as there may be other equally effective embodiments.

FIG. 1 is an isometric view of an embodiment of a gypsum board.

FIG. 2 is a sectional top view of the gypsum board of FIG. 1, taken along the line 2-2 of FIG. 1.

FIG. 3 is photograph of various embodiments of gypsum boards and a conventional gypsum board, with each board sectioned.

FIGS. 4A-4D depict schematic sectional front views of various embodiments of gypsum panels.

FIGS. 5A and 5B illustrate plots of density and specific modulus, respectively, for a conventional gypsum board and embodiments of gypsum boards.

FIGS. 6A and 6B illustrate plots of simulated sound transmission loss responses for a conventional gypsum board and embodiments of gypsum boards.

The use of the same reference symbols in different drawings indicates similar or identical items.

### DETAILED DESCRIPTION

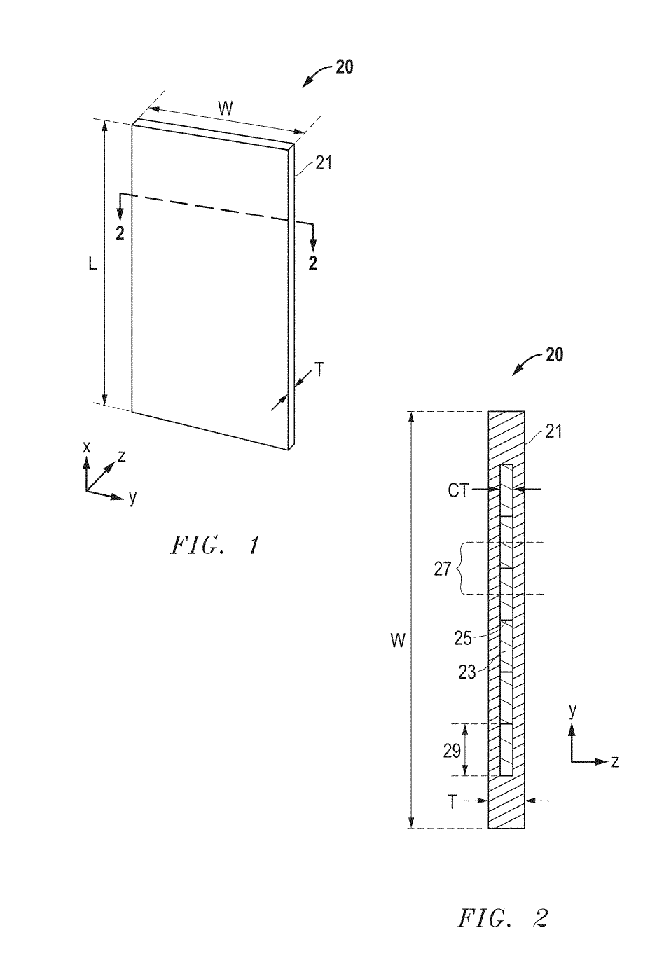

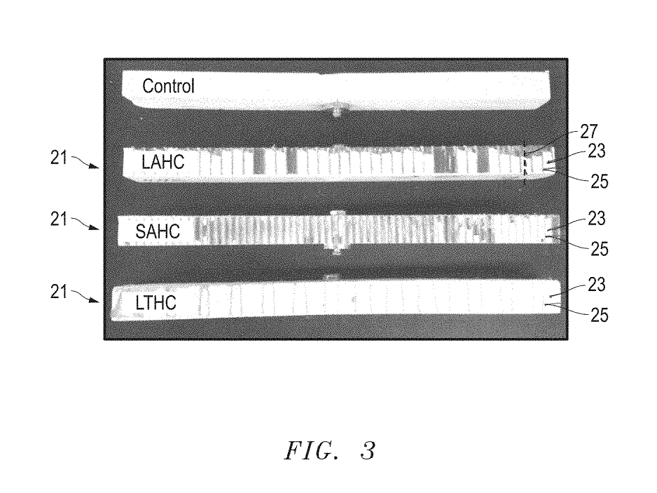

Embodiments of a system, method and apparatus for a gypsum panel are disclosed. For example, FIGS. 1 and 2 depict a gypsum panel 20 having gypsum body 21 with a length L along an x-axis, a width W along a y-axis, and a thickness T along a z-axis. Versions of the gypsum body 21 may include at least one core 23 embedded at least partially within the gypsum body 21. Examples of the core 23 may include a hollow, open cell structure having walled elements 25. The walled elements 25 may have axes 27 that may be substantially parallel to each other and the z-axis.

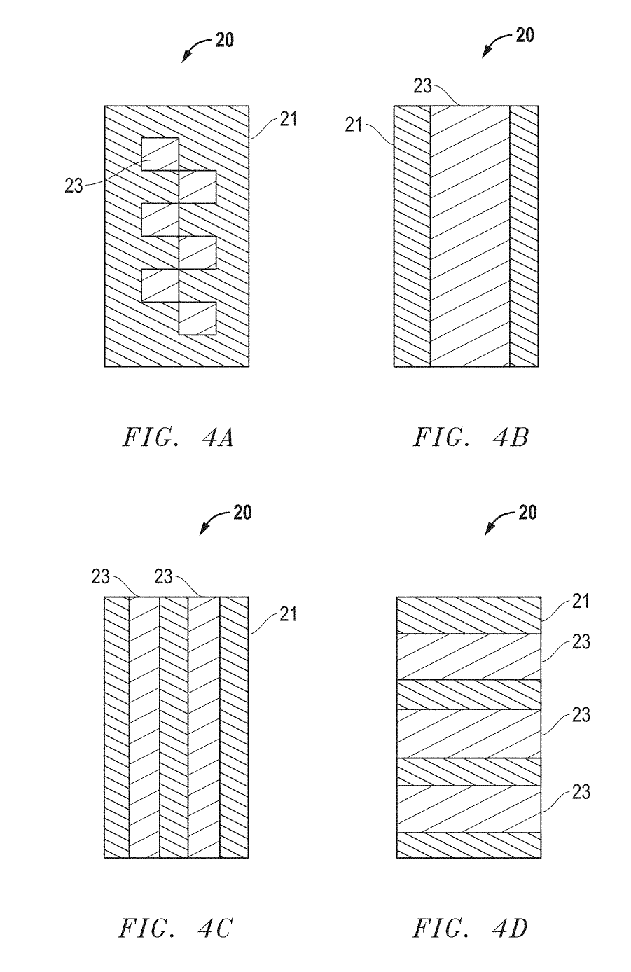

In some embodiments (FIG. 3), the walled elements 25 may be substantially filled with a same material as the gypsum body 21, such that the gypsum body 21 is substantially solid with few or no porous elements. For example, the core 23 may be substantially filled along at least one of the x-axis, y-axis or z-axis.

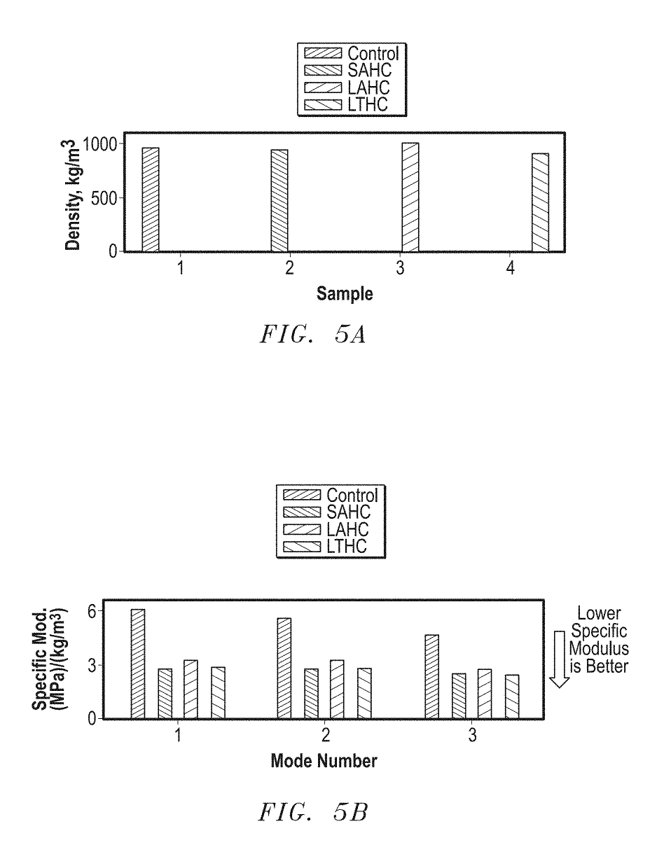

In some examples, the core 23 can be substantially a same size in length and width as the gypsum body 21. Embodiments of the core 23 may be completely embedded within the gypsum body 21 (FIGS. 2 and 4A), such that no portion of the core 23 is visible from an exterior of the gypsum body 21. Examples of the core 23 may include a variety of materials, such as at least one of paper, cardboard, metallic, plastic, polycarbonate, aramid, fabric, reinforcement, woven fiberglass or non-woven fiberglass. In one version, the core 23 is not metallic. Embodiments of the gypsum panel 20 may include a plurality of cores 23 (FIGS. 4A, 4C and 4D). The cores 23 may have axes 27 that are parallel or configured at different orientations with respect to the axes 27.

Embodiments of the walled elements 25 may include at least one of hexagonal walled, honeycomb structures, triangular walled structures or circular structures. Some versions of the walled element 25 may have a maximum dimension 29 (FIG. 2) in an x-y plane. For example, the maximum dimension 29 of the walled element 25 can be at least about 1/16 inches, such as at least about ⅛ inches, at least about ¼ inches, at least about ½ inches, or even at least about 1 inch. Other versions of the maximum dimension 29 can be not greater than about 12 inches, such as not greater than about 10 inches, not greater than about 8 inches, not greater than about 6 inches, or even not greater than about 4 inches. Alternatively, the maximum dimension 29 can be in a range between any of these values.

The gypsum panel 20 may be defined with a stiffness that is less than that of an identical gypsum panel without the core 23. For example, the stiffness can be at least about 1% less than that of an identical gypsum panel without the core 23. In other versions, the stiffness can be at least about 5% less, such as at least about 10% less, at least about 15% less, at least about 20% less, or even at least about 25% less. In another example, the stiffness can be not greater than 60% less than that of an identical gypsum panel without the core 23. Still other versions can be not greater than 55% less, not greater than 50% less, not greater than 45% less, or even not greater than 40% less. Alternatively, the stiffness can be in a range between any of these values. Stiffness may be tested in accordance with ASTM E756-05, the standard test method for measuring vibration-damping properties of materials, or ISO16940:2008, measurement of the mechanical impedance of laminated glass.

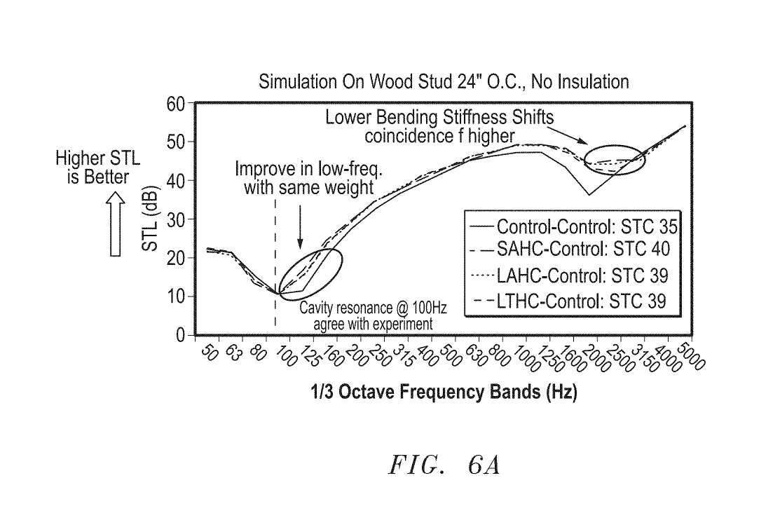

As depicted in FIG. 5A, conventional gypsum bodies have a density on the order of about 1000 kg/m³. Embodiments of the gypsum panel 20 can have a density that is less than that of an identical gypsum panel without the core 23. For example, the density can be at least about 0.1% less than that of an identical gypsum panel without the core 23. In other versions, the density can be at least about 1% less, such as at least about 5% less, at least about 10% less, at least about 15% less, or even at least about 20% less. Another example can be not greater than 30% less than that of an identical gypsum panel without the core 23. Still other versions can be not greater than 25% less, not greater than 20% less, not greater than 15% less, or even not greater than 10% less. Alternatively, the density can be in a range between any of these values.

In some versions, the one or more cores 23 of the gypsum panel 20 may include a core thickness (CT) along the z-axis, as shown in FIG. 2. For example, each of the core thicknesses CT can be at least about 0.01 inches, such as at least about 0.05 inches, at least about 0.10 inches, at least about 0.15 inches, or even at least about 0.20 inches. Other versions of the core thickness CT can be not greater than about 1 inch, such as not greater than about 0.75 inches, not greater than about 0.50 inches, not greater than about 0.40 inches, or even not greater than about 0.30 inches. Alternatively, the core thickness CT can be in a range between any of these values. Embodiments of the gypsum panel 20 may include examples wherein at least two of the core thicknesses CT differ as well.

Other embodiments of the gypsum panel 20 may include the core 23 with the core thickness CT (FIG. 2), and a ratio of the core thickness CT to the gypsum body thickness (T). For example, the ratio CT:T can be at least about 1:1, such as at least about 1:2, at least about 1:3, at least about 1:5, or even at least about 1:10. Other versions of the ratio CT:T can be not greater than about 1:20, not greater than about 1:18, not greater than about 1:16, not greater than about 1:14, or even not greater than about 1:12. Alternatively, the ratio CT:T can be in a range between any of these values.

The mechanical impedance method (MIM), described in ISO16940:2008, measurement of the mechanical impedance of laminated glass, was used to measure the elastic properties of samples of gypsum panels 20. The specific modulus normalized relative to the density shows a greater than 50% reduction in specific modulus, as shown in FIG. 5B.

Accordingly, some versions of the gypsum panel 20 may include a specific modulus that may be less than that of an identical gypsum panel without the core 23. For example, the specific modulus can be at least about 10% less than that of an identical gypsum panel without the core 23. Other versions of the specific modulus can be at least about 15% less, such as at least about 20% less, at least about 25% less, at least about 30% less, or even at least about 35% less. Some examples of the specific modulus can be not greater than about 90% less than that of an identical gypsum panel without the core 23. Still other versions of the specific modulus can be not greater than about 80%, not greater than about 70%, not greater than about 60%, or even not greater than about 50%. Alternatively, the specific modulus can be in a range between any of these values.

In some embodiments, the gypsum body 21 may further include a second layer embedded at least partially within the gypsum body 21, as shown in the FIGS. 4A-4D. The second layer may be displaced relative to the core in any axial direction. For example, the second layer may have at least one of a different structure or a different material than the core 23. Additionally, the gypsum body 21 may have substantially smooth exterior surfaces, or it may have a texture on an exterior surface thereof. For example, the texture on the exterior of the gypsum body 21 could be formed by the core 23.

Versions of the gypsum panel 20 may include an exterior layer on an exterior surface of the gypsum body 21. For example, the exterior layer may have the walled elements 25. Those walled elements 25 also may be substantially filled with the same material as the gypsum body 21. Alternatively, the exterior layer may comprise a different material than the core 23. In one version, the exterior layer comprises paper. In another version, the gypsum body 21 has two opposing surfaces in x-y planes, and each of the two opposing surfaces comprises a paper layer on exteriors thereof. In addition, the exterior layer may comprise a second layer. For example, the second layer can be a same material as the core 23.

Versions of the cores 23 may be spaced apart from each other such that they do not contact each other (FIGS. 4C and 4D). In another example, the cores 23 may be arrayed in a geometric pattern (FIGS. 4A-4D). An embodiment may include cores 23 with at least two layers along the z-axis. The at least two layers may contact each other, or the at least two layers may be spaced apart from each other, such as along the z-axis.

Embodiments of the core 23 may be arrayed in a variety of configurations, such as a checkerboard pattern (FIG. 4A). Some examples, of the core 23 may extend for an entire length of the gypsum body 21 (FIGS. 4B and 4C). Other examples of the core 23 may include a core width that is less than the width of the gypsum body (FIGS. 4A-4C). However, the core 23 may extend for an entire width of the gypsum body 21 (FIG. 4D). Optionally, the core 23 may be centered with respect to at least one of the x-axis, y-axis or z-axis. Alternatively, the core 23 may be arrayed in a stripe pattern with respect to an x-y plane (FIGS. 4B-4D). Some versions of the core 23 may include a core length that is less than the length of the gypsum body 21 (FIGS. 4A and 4D). In still another version, the gypsum panel 20 may include a plurality of cores 23 that may be distributed substantially randomly within the gypsum body 21.

Applications for the gypsum panel 20 may include walls for buildings. For example, the gypsum panel 20 may be configured to comprise a double-leaf wall comprising two gypsum panels 20 on studs, such as conventional wood studs or metal studs. The wall may or may not be insulated. In some versions, the double-leaf wall may be configured to comprise a sound transmission loss (STL) in decibels (dB).

The reduction in specific modulus (FIG. 5B) described herein leads to higher coincidence frequency between about 2 kHz to about 4 kHz, which yields improved sound transmission loss, or improved acoustic performance. Walls constructed with gypsum panels 20 may have a STL that is less than that of an identical double-leaf wall without cores 23.

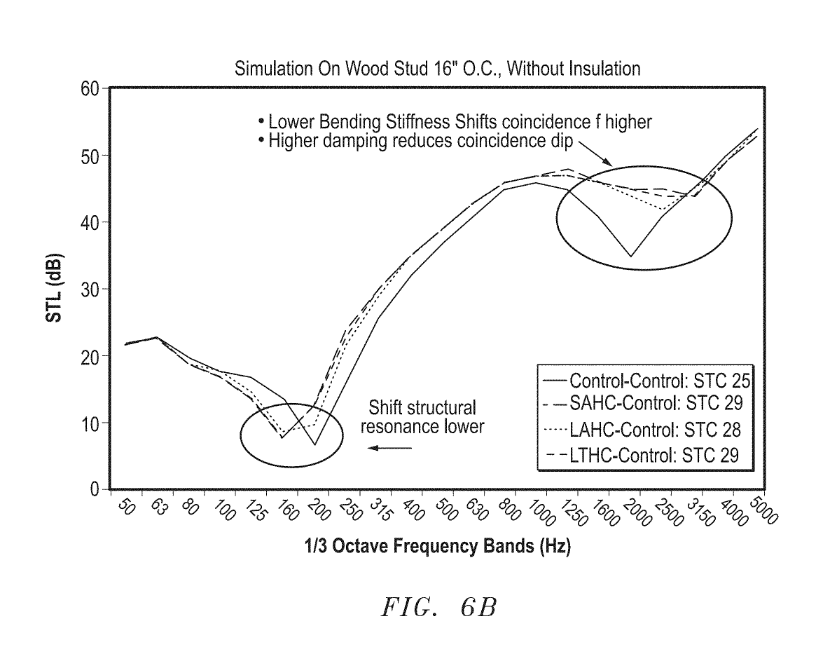

For example, FIGS. 6A and 6B depict simulation of STL for double-leaf walls with wood studs on 16-inch and 24-inch over-the-center spacing. The samples tested included (1) gypsum panels 20, and (2) control samples formed from identical gypsum panels with cores 23. The trend clearly demonstrates improvement at both low-frequency (structural resonance dominated) and high frequency (coincidence controlled).

Accordingly, a double-leaf wall constructed with gypsum panels 20 may have a STL that is at least about 1% less than that of an identical double-leaf wall without cores 23. In other examples, the STL can be at least about 5% less, at least about 10% less, at least about 15% less, or even at least about 20% less. Other versions of the STL can be not greater than about 50% less than that of an identical double-leaf wall without cores 23. Still other versions of the STL can be not greater than about 50%, such as not greater than about 45%, not greater than about 40%, not greater than about 35%, or even not greater than about 30%. Alternatively, the STL can be in a range between any of these values.

In some embodiments, the improvement in STL performance may be tuned to occur in a selected frequency range, as shown in FIG. 6. In one version, the STL improvement may occur in a frequency range of about 100 Hz to about 200 Hz (⅓ octave frequency bands). As an example, the 100 Hz center frequency band is typically between about 90 Hz to about 112 Hz. The dB in this band is an average of sound pressure level between about 90 to about 112 Hz. In some embodiments, below 250 Hz, a structural resonance of the double-leaf wall is shifted to a frequency of about 10% to about 25% lower than that of an identical double-leaf wall without cores.

In another example, the improvement in STL performance may occur in a frequency range of about 1000 Hz to about 2500 Hz (⅓ octave frequency bands). In some embodiments, above 1000 Hz, a coincidental resonance of the double-leaf wall is shifted to a frequency of about 20% to about 60% greater than that of an identical double-leaf wall without cores.

Embodiments of the gypsum panel 20 may be designed to meet some industry standards. For example, the gypsum panel 20 may be configured to satisfy the strength requirements according to ASTM C473. In another example, the gypsum panel 20 may be configured to satisfy the fire rating requirements of ASTM E814.

Versions of the gypsum panel 20 may be configured to contain a selected minimum of gypsum (e.g., CaSO₄) in the final product. For example, the gypsum panel 20 may be configured to contain at least about 70% gypsum, as prescribed by ASTM C22. In other versions, the gypsum panel 20 may be configured to be formed during manufacturing from a slurry comprising gypsum and water. For example, the slurry may include at least about 60% to about 90% gypsum. In some embodiments, the open cell structure of the core 23 may be at least partially filled with a material. The material may be added to the core 23 before introduction to the gypsum body 21 to form a finished gypsum panel 20. In some embodiments, the material may form a pre-defined pattern before introduction to the gypsum body 21 to form a finished gypsum panel 20. The material may be used to pre-fill the open cell structure of the core 23. The material may be the same as or different than gypsum. The material may include at least one of paper, cardboard, metallic, plastic, polycarbonate, aramid, fabric, reinforcement, woven fiberglass or non-woven fiberglass, or may be another type. The material may be a foam, a polymer, or may be another type. In one embodiment the material may be foam gypsum with a density of between about 5% to about 50% different than the gypsum used in the slurry.

The embodiments disclosed herein relate to the structure of an acoustic gypsum board. The gypsum board may include features such as an embedded structure that can reduce the stiffness of the gypsum substrate in a controlled manner for the desired acoustic benefit, while still maintaining all other strength requirements and normal use. The open cell embedded structure can separate the continuous gypsum into isolated pockets within the structure.

The disclosed embodiments are fundamentally different than prior art solutions, since they define the gypsum board as a single layer composite structure. The use of an open cell structure in the gypsum substrate and the use of the structure and its interaction with the gypsum matrix can be used to tailor the elastic mechanical properties of the composite panel to achieve the desired acoustic performance.

### Embodiment 1

A gypsum panel, comprising: a gypsum body having a length along an x-axis, a width along a y-axis, a thickness along a z-axis; and a core embedded at least partially within the gypsum body, and the core comprises a hollow, open cell structure having walled elements with axes that are substantially parallel to each other and the z-axis, and the walled elements are substantially filled with a same material as the gypsum body.

### Embodiment 2

The gypsum panel of embodiment 1, wherein the core is substantially a same size in length and width as the gypsum body.

### Embodiment 3

The gypsum panel of embodiment 1, wherein the core is completely embedded within the gypsum body, such that no portion of the core is visible from an exterior of the gypsum body.

### Embodiment 4

The gypsum panel of embodiment 1, wherein the core comprises at least one of paper, cardboard, metallic, plastic, polycarbonate, aramid, fabric, reinforcement, woven fiberglass or non-woven fiberglass.

### Embodiment 5

The gypsum panel of embodiment 1, wherein the core is not metallic.

### Embodiment 6

The gypsum panel of embodiment 1, wherein the walled elements comprise at least one of hexagonal walled, honeycomb structures, triangular walled structures or circular structures.

### Embodiment 7

The gypsum panel of embodiment 1, wherein each walled element comprises a maximum dimension in an x-y plane in a range of about 1/16 inch to about 12 inches.

### Embodiment 8

The gypsum panel of embodiment 1, wherein the gypsum panel has a stiffness that is in a range of about 1% to about 60% less than that of an identical gypsum panel without the core.

### Embodiment 9

The gypsum panel of embodiment 1, wherein the gypsum panel has density that is in a range of about 0.1% to about 30% less than that of an identical gypsum panel without the core.

### Embodiment 10

The gypsum panel of embodiment 1, wherein the core comprises a plurality of cores having axes that are parallel or configured at different orientations with respect to the axes.

### Embodiment 11

The gypsum panel of embodiment 10, wherein the cores comprise core thicknesses (CT) along the z-axis, and each of the core thicknesses is in a range of about 0.01 inches to about 0.5 inches.

### Embodiment 12

The gypsum panel of embodiment 11, wherein at least two of the core thicknesses differ.

### Embodiment 13

The gypsum panel of embodiment 10, wherein the cores are spaced apart from each other such that they do not contact each other.

### Embodiment 14

The gypsum panel of embodiment 10, wherein the cores are arrayed in a geometric pattern.

### Embodiment 15

The gypsum panel of embodiment 10, wherein cores comprise at least two layers along the z-axis.

### Embodiment 16

The gypsum panel of embodiment 15, wherein the at least two layers contact each other.

### Embodiment 17

The gypsum panel of embodiment 15, wherein the at least two layers are spaced apart from each other along the z-axis.

### Embodiment 18

The gypsum panel of embodiment 1, wherein the gypsum body further comprises a second layer embedded at least partially within the gypsum body.

### Embodiment 19

The gypsum panel of embodiment 18, wherein the second layer comprises at least one of a different structure or a different material than the core.

### Embodiment 20

The gypsum panel of embodiment 1, wherein the core has a core thickness (CT) along the z-axis, and a ratio of the core thickness CT to the gypsum body thickness (T) is in a range of about 1:1≦CT:T≦1:20.

### Embodiment 21

The gypsum panel of embodiment 1, wherein the core has a core thickness (CT) along the z-axis, and the core thickness is in a range of about 0.01 inches to about 1.0 inches.

### Embodiment 22

The gypsum panel of embodiment 1, wherein the gypsum body comprises substantially smooth exterior surfaces.

### Embodiment 23

The gypsum panel of embodiment 1, wherein the gypsum body comprises a texture on an exterior surface thereof.

### Embodiment 24

The gypsum panel of embodiment 23, wherein the texture is formed by the core.

### Embodiment 25

The gypsum panel of embodiment 1, wherein the gypsum body further comprises an exterior layer on an exterior surface of the gypsum body.

### Embodiment 26

The gypsum panel of embodiment 25, wherein the exterior layer comprises the walled elements that also are substantially filled with the same material as the gypsum body.

### Embodiment 27

The gypsum panel of embodiment 25, wherein the exterior layer comprises a different material than the core.

### Embodiment 28

The gypsum panel of embodiment 25, wherein the exterior layer comprises paper.

### Embodiment 29

The gypsum panel of embodiment 28, wherein the gypsum body has two opposing surfaces in x-y planes, and each of the two opposing surfaces comprises a paper layer on exteriors thereof.

### Embodiment 30

The gypsum panel of embodiment 25, wherein the exterior layer comprises a second layer.

### Embodiment 31

The gypsum panel of embodiment 30, wherein the second layer comprises a same material as the core.

### Embodiment 32

The gypsum panel of embodiment 1, wherein the core is arrayed in a checkerboard pattern.

### Embodiment 33

The gypsum panel of embodiment 1, wherein the core extends for an entire length of the gypsum body.

### Embodiment 34

The gypsum panel of embodiment 1, wherein the core has a core width that is less than the width of the gypsum body.

### Embodiment 35

The gypsum panel of embodiment 1, wherein the core is centered with respect to at least one of the x-axis, y-axis or z-axis.

### Embodiment 36

The gypsum panel of embodiment 1, wherein the core is arrayed in a stripe pattern with respect to an x-y plane.

### Embodiment 37

The gypsum panel of embodiment 1, wherein the core extends for an entire width of the gypsum body.

### Embodiment 38

The gypsum panel of embodiment 1, wherein the core has a core length that is less than the length of the gypsum body.

### Embodiment 39

The gypsum panel of embodiment 1, wherein the core comprises a plurality of cores distributed substantially randomly within the gypsum body.

### Embodiment 40

The gypsum panel of embodiment 1, wherein the core is substantially filled along at least one of the x-axis, y-axis or z-axis.

### Embodiment 41

The gypsum panel of embodiment 1, wherein the gypsum panel comprises a specific modulus that is in a range of about 10% to about 90% less than that of an identical gypsum panel without the core.

### Embodiment 42

The gypsum panel of embodiment 1, wherein the gypsum panel is configured in a double-leaf wall comprising two gypsum panels connected via studs with or without insulation. The acoustic performance of such double-leaf wall partition, characterized by a sound transmission loss (STL) response in decibels (dB), shows reduced sound transmission (ST) of about 1% to 50% than that of an identical double-leaf wall without cores, yielding an improvement in STL performance.

### Embodiment 43

The gypsum panel of embodiment 42, wherein the improvement in STL performance occurs in a frequency range of about 100 Hz to about 200 Hz.

### Embodiment 44

The gypsum panel of embodiment 42, wherein the improvement in STL performance occurs in a frequency range of about 1000 Hz to about 2500 Hz.

### Embodiment 45

The gypsum panel of embodiment 42, wherein, below 250 Hz, a structural resonance of the double-leaf wall is shifted at least one ⅓ Octave band lower, or to a frequency of about 10% to about 25% lower than that of the identical double-leaf wall without cores.

### Embodiment 46

The gypsum panel of embodiment 42, wherein above 1000 Hz, a coincidence resonance of the double-leaf wall is shifted at least one ⅓ octave band higher, or to a frequency of about 20% to about 60% greater than that of the identical double-leaf wall without cores.

### Embodiment 47

The gypsum panel of embodiment 1, wherein the gypsum panel satisfies strength requirements according to ASTM C473.

### Embodiment 48

The gypsum panel of embodiment 1, wherein the gypsum panel satisfies fire rating requirements of ASTM E814.

### Embodiment 49

The gypsum panel of embodiment 1, wherein the gypsum panel comprises at least about 70% gypsum.

### Embodiment 50

The gypsum panel of embodiment 1, wherein the gypsum panel is configured to be formed from a slurry comprising gypsum in a range of about 60% to about 90% of the slurry.

### Embodiment 51

A gypsum panel, comprising: a gypsum body having a length along an x-axis, a width along a y-axis, a thickness along a z-axis; and a core embedded at least partially within the gypsum body, and the core comprises a hollow, open cell structure having walled elements with axes that are substantially parallel to each other and the z-axis, and the walled elements are substantially filled with a gypsum material.

### Embodiment 52

A gypsum panel, comprising: a gypsum body having a length along an x-axis, a width along a y-axis, a thickness along a z-axis; and a core embedded at least partially within the gypsum body, and the core comprises a hollow, open cell structure having walled elements with axes that are substantially parallel to each other and the z-axis, and the walled elements are substantially filled with a material.

This written description uses examples to disclose the embodiments, including the best mode, and also to enable those of ordinary skill in the art to make and use the invention. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

1. A gypsum panel, comprising:
a gypsum body having a length along an x-axis, a width along a y-axis, a thickness along a z-axis; and
a core embedded at least partially within the gypsum body, and the core comprises a hollow, open cell structure having walled elements with axes that are substantially parallel to each other and the z-axis, and the walled elements are substantially filled with a same material as the gypsum body.

2. The gypsum panel of claim 1, wherein the core is substantially a same size in length and width as the gypsum body.

3. The gypsum panel of claim 1, wherein the core is completely embedded within the gypsum body, such that no portion of the core is visible from an exterior of the gypsum body.

4. The gypsum panel of claim 1, wherein the core comprises at least one of paper, cardboard, metallic, plastic, polycarbonate, aramid, fabric, reinforcement, woven fiberglass or non-woven fiberglass.

5. (canceled)

6. The gypsum panel of claim 1, wherein the walled elements comprise at least one of hexagonal walled, honeycomb structures, triangular walled structures or circular structures.

7-9. (canceled)

10. The gypsum panel of claim 1, wherein the core comprises a plurality of cores having axes that are parallel or configured at different orientations with respect to the axes.

11. The gypsum panel of claim 10, wherein the cores comprise core thicknesses (CT) along the z-axis, and each of the core thicknesses is in a range of about 0.01 inches to about 0.5 inches.

12-14. (canceled)

15. The gypsum panel of claim 10, wherein cores comprise at least two layers along the z-axis.

16. (canceled)

17. (canceled)

18. The gypsum panel of claim 1, wherein the gypsum body further comprises a second layer embedded at least partially within the gypsum body.

19. (canceled)

20. The gypsum panel of claim 1, wherein the core has a core thickness (CT) along the z-axis, and a ratio of the core thickness CT to the gypsum body thickness (T) is in a range of about 1:1≦CT:T≦1:20.

21. The gypsum panel of claim 1, wherein the core has a core thickness (CT) along the z-axis, and the core thickness is in a range of about 0.01 inches to about 1.0 inches.

22. (canceled)

23. The gypsum panel of claim 1, wherein the gypsum body comprises a texture on an exterior surface thereof.

24. (canceled)

25. The gypsum panel of claim 1, wherein the gypsum body further comprises an exterior layer on an exterior surface of the gypsum body.

26. (canceled)

27. The gypsum panel of claim 25, wherein the exterior layer comprises a different material than the core.

28. (canceled)

29. (canceled)

30. The gypsum panel of claim 25, wherein the exterior layer comprises a second layer.

31-35. (canceled)

36. The gypsum panel of claim 1, wherein the core is arrayed in a stripe pattern with respect to an x-y plane.

37. (canceled)

38. The gypsum panel of claim 1, wherein the core has a core length that is less than the length of the gypsum body.

39. (canceled)

40. The gypsum panel of claim 1, wherein the core is substantially filled along at least one of the x-axis, y-axis or z-axis.

41. (canceled)

42. The gypsum panel of claim 1, wherein the gypsum panel is configured in a double-leaf wall comprising two gypsum panels connected via studs with or without insulation. The acoustic performance of such double-leaf wall partition, characterized by a sound transmission loss (STL) response in decibels (dB), shows reduced sound transmission (ST) of about 1% to 50% than that of an identical double-leaf wall without cores, yielding an improvement in STL performance.

43-50. (canceled)

51. A gypsum panel, comprising:
a gypsum body having a length along an x-axis, a width along a y-axis, a thickness along a z-axis; and
a core embedded at least partially within the gypsum body, and the core comprises a hollow, open cell structure having walled elements with axes that are substantially parallel to each other and the z-axis, and the walled elements are substantially filled with a gypsum material.

52. A gypsum panel, comprising:
a gypsum body having a length along an x-axis, a width along a y-axis, a thickness along a z-axis; and
a core embedded at least partially within the gypsum body, and the core comprises a hollow, open cell structure having walled elements with axes that are substantially parallel to each other and the z-axis, and the walled elements are substantially filled with a material.
